(19) United States
(12) Patent Application Publication
(10) Pub. No.: US 2015/0327013 A1
(43) Pub. Date: Nov. 12, 2015

(54) APPARATUS AND METHOD FOR RECOGNIZING LOCATION TYPE

(71) Applicant: Electronics and Telecommunications Research Institute, Daejeon (KR)

(72) Inventor: Wan Seok KIM, Daejeon (KR)

(21) Appl. No.: 14/668,871

(22) Filed: Mar. 25, 2015

(30) Foreign Application Priority Data
May 12, 2014 (KR) 10-2014-0056744

(51) Int. Cl. H04W 4/02

(52) U.S. Cl. CPC H04W 4/021; H04W 4/028

(57) ABSTRACT

Provided herein is a location type recognition method and apparatus for intuitive service connection, the method including detecting a new service object apparatus capable of providing services to a user; in response to the new service object apparatus being detected, obtaining information on the new service object apparatus from the new service object apparatus; and defining a location type of a predetermined place where the user is located using information on the new service object apparatus.

### CROSS-REFERENCE TO RELATED APPLICATION

The present application claims priority to Korean patent application number 10-2014-0056744, filed on May 12, 2014, the entire disclosure of which is incorporated herein in its entirety by reference.

### BACKGROUND

1. Field of Invention

Various exemplary embodiments of the present invention relate to an apparatus and method for recognizing a location type, and more particularly, to an apparatus for recognizing a location type for an intuitive service connection, and a method thereof.

2. Description of Related Art

Due to the recent gradual intellectualization of smart phones, apparatuses nearby a user using a smart phone gradually become intelligent as well, and the number of usable apparatuses is increasing. These apparatuses nearby the user are installed intentionally by the user according to the purpose of usage, and the user wants to receive the services suitable to necessary situations. Nevertheless, the user is often placed in environments where it is difficult to manipulate or use these apparatuses appropriately due to the increase of various apparatuses nearby the user and the complexity and difficulty in manipulating these apparatuses.

Thus, it is necessary to conduct research on defining a user's location type in order to provide customized services to the user according to place and the apparatuses located in that place.

### SUMMARY

A purpose of embodiments of the present invention is to enable intuitive service connection of an object apparatus that provides services to a user.

Another purpose of embodiments of the present invention is to provide information on a location type so that a smart apparatus may map a user's situation, intentions, and information relativity on a service apparatus and identify the user's service demands per place even without the user's command.

One embodiment of the present invention provides a semiconductor device including a location type recognition method including detecting a new service object apparatus capable of providing services to a user; in response to the new service object apparatus being detected, obtaining information on the new service object apparatus from the new service object apparatus; and defining a location type of a predetermined place where the user is located using information on the new service object apparatus.

The method may further include, in response to the new service object apparatus being detected, determining whether or not the new service object apparatus is an existing service object apparatus that was determined before, wherein the obtaining information on the new service object apparatus is performed after it is determined that the new service object apparatus is not the existing service object apparatus.

The detecting the new service object apparatus may further include, in response to the new service object apparatus not being detected, determining whether or not the existing service object apparatus that was detected before is still being detected; and in response to the existing service object apparatus not being detected, deleting information on the existing service object apparatus.

The defining a location type may include measuring a stay time at the predetermined place by the user; and determining a past visiting frequency at the predetermined place by the user.

The defining a location type may define a location type of the predetermined place based on the stay time and the past visiting frequency.

The defining a location type may define a location of the predetermined place as one of a stay place, working place, and visiting place based on the stay time.

The defining a location type may define a location of the predetermined place as at least one of a cycle visiting place and temporary visiting place.

The defining a location type may define a location type of the predetermined place using at least one of GPS information and visual information of the user.

Another embodiment of the present invention provides a location type recognition apparatus including a new apparatus detector for detecting a new object apparatus capable of providing services to a user; an information managing for, in response to the new service object apparatus being detected, obtaining information the new service object apparatus from the new service object apparatus; and a location type definer for defining a location type of a predetermined place where the user is located using the information on the new service object apparatus.

The apparatus may further include an apparatus determiner for, in response to the new service object apparatus being detected, determining whether or not the new service object apparatus is an existing service object apparatus that was determined before, wherein the information manager obtaining information on the new service object apparatus is performed after it is determined that the new service object apparatus is not the existing service object apparatus.

The new apparatus detector may further include, in response to the new service object apparatus not being detected, an existing apparatus detecting manager for determining whether or not the existing service object apparatus that was detected before is still being detected; and the information manager, in response to the existing service object apparatus not being detected, deleting information on the existing service object apparatus.

The defining a location type may include a purpose identifier for measuring a stay time at the predetermined place by the user; and a format identifier for determining a past visiting frequency at the predetermined place by the user.

The location type definer may define a location type of the predetermined place based on the stay time and the past visiting frequency.

The location type definer may define a location type of the predetermined place as one of a stay place, working place, and visiting place based on the stay time.

The location type definer may define a location type of the predetermined place as at least one of a cycle visiting place and temporary visiting place.

The location type definer may define a location type of the predetermined place using at least one of GPS information and visual information of the user.

According to embodiments of the present invention, it is possible to enable intuitive service connection of an object apparatus that provides services to a user.

According to embodiments of the present invention, it is possible to provide information on a location type so that a smart apparatus may map a user's situation, intentions, and information relativity on a service apparatus and identify the user's service demands per place even without the user's command. Accordingly, embodiments of the present invention enable providing voluntary services upon discovering services such as music, video, lamp, and air conditioning.

### BRIEF DESCRIPTION OF THE DRAWINGS

The above and other features and advantages of the present invention will become more apparent to those of ordinary skill in the art by describing in detail exemplary embodiments with reference to the attached drawings in which:

FIG. 1 is a flowchart for explaining a location type recognition method according to an embodiment of the present invention;

FIG. 2 is a flowchart for explaining a location type defining method in a location type recognition method according to an embodiment of the present invention;

FIG. 3 is an embodiment of steps for defining a location type according to an embodiment of the present invention;

FIG. 4 is a block diagram illustrating a location type recognition apparatus according to an embodiment of the present invention; and

FIG. 5 is a block diagram for illustrating a location type definer in a location type recognition apparatus according to an embodiment of the present invention.

### DETAILED DESCRIPTION

The present invention will be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the present invention to those skilled in the art. In the drawings, a thicknesses and a distance of components are exaggerated compared to an actual physical thickness and interval for convenience of illustration. In the following description, detailed explanation of known related functions and constitutions may be omitted to avoid unnecessarily obscuring the subject manner of the present invention. Like reference numerals refer to like elements throughout the specification and drawings.

A location type recognition method according to an embodiment of the present invention will be described hereinafter.

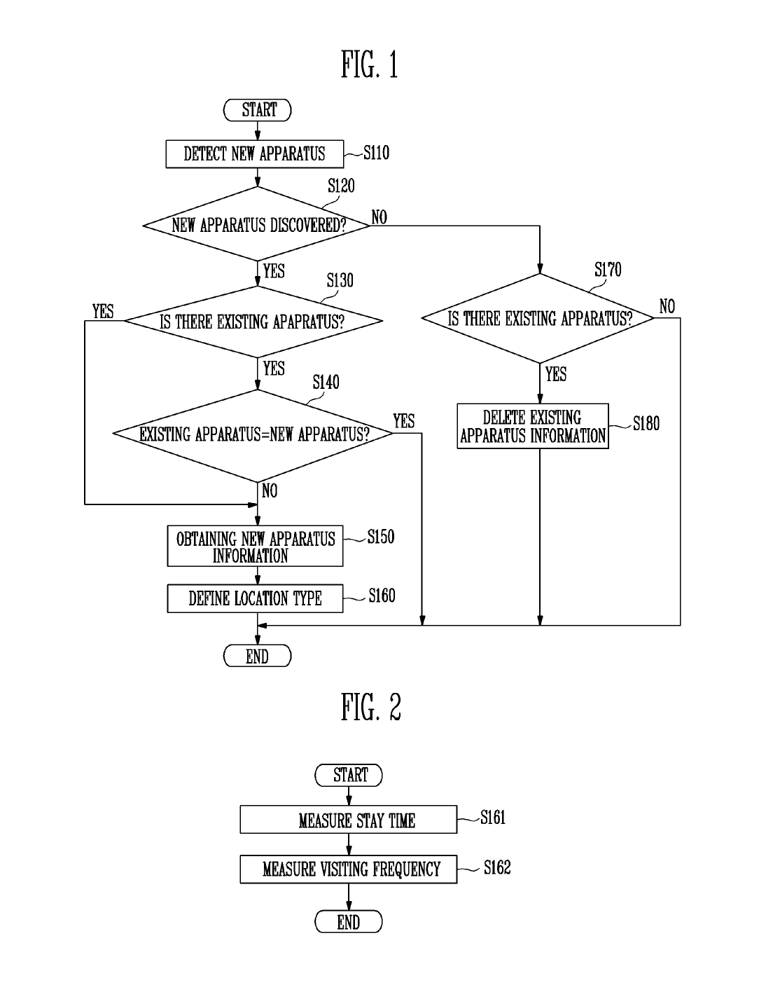

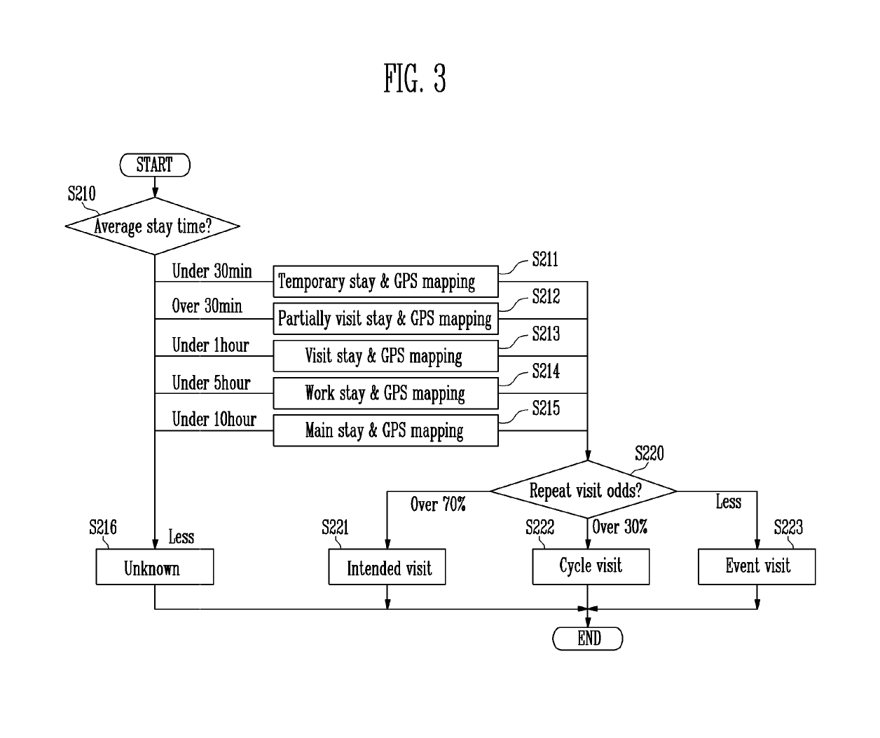

FIG. 1 is a flowchart for explaining a location type recognition method according to an embodiment of the present invention. FIG. 2 is a flowchart for explaining a location type defining method in a location type recognition method according to an embodiment of the present invention. FIG. 3 is an embodiment of steps for defining a location type according to an embodiment of the present invention.

Referring to FIG. 1, a location type recognition method according to an embodiment of the present invention detects a new service object apparatus capable of providing services to a user (S110).

Furthermore, it is determined whether or not a new service object apparatus is discovered (S120).

In response to a new service object apparatus being detected at step S120, it is determined whether or not there is an existing service object apparatus that was detected before (S130).

In response to there being an existing service object apparatus as a result of the determination at step S130, it is determined whether or not the new service object apparatus discovered at step S120 is the existing service object apparatus (S140). In response to it being determined that the new service object apparatus is the existing service object apparatus as a result of the determination at step S140, recognizing a location type is ended or re-started.

In response to it being determined that the new service object apparatus is not the new service object apparatus, information on the new service object apparatus is obtained from the new service object apparatus (S150).

Furthermore, using the information on the new service object apparatus, a location type of a predetermined location where the user is located is defined (S160).

More specifically, the step S160 is made by measuring a stay time of the user at the predetermined place (S161), and determining a past visiting frequency of the past regarding the predetermined place (S162). Herein, at step S160, a location type of the predetermined place is defined based on the stay time and the visiting frequency of the past.

Herein, based on the stay time, the location type of the predetermined place may be defined as one of a stay place, working place and visiting place.

Furthermore, herein, based on the visiting frequency of the past, the location type of the predetermined place may be defined as one of a cycle visiting place and a temporary visiting place.

Furthermore, at step S160, using at least one of GPS information and time information of the user, the location type of the predetermined place may be defined.

Furthermore, in response to it being determined that the new service object apparatus is not discovered at step S120, it is determined whether the existing service object apparatus that was detected before exists or has disappeared (S170). In response to it being determined that the existing service object apparatus has disappeared at step S170, information on the existing service object apparatus is deleted, and a time stamp calculation is processed (S180). In response to it being determined that the existing service object apparatus still exists at step S170, recognizing a location type is ended or re-started.

FIG. 3 illustrates an example of performing step S160.

First of all, an average stay time is measured from the stay time (S210). Herein, in response to the stay time being less than 30 minutes, it is determined as a temporary stay and a GPS mapping may be performed (S211). Furthermore, in response to the stay time being 30 minutes or more, it is determined as a partially visit stay and a GPS mapping may be performed (S212). Furthermore, in response to the stay time being 30 minutes or more but less than 1 hour, it is determined as a partially visit stay and a GPS mapping may be performed (S213). Furthermore, in response to the stay time being 1 hour or more but less than 5 hours, it is determined as a work stay and a GPS mapping may be performed (S214). Furthermore, in response to the stay time being 5 hour or more but less than 10 hours, it is determined as a main stay visit and a GPS mapping may be performed (S215). Other stay times may be determined by unknown locations (S216).

Furthermore, a repeat visit odds may be determined (S220) to determine whether it is an intended visit (S221), cycle visit (S222), or event visit (S223).

A location type recognition method according to an embodiment of the present invention may be realized as a program command that may be performed through various computer means, and be recorded in a computer readable recording medium. The computer readable recording medium may include a program command, data file, and data structure, or a combination thereof. The program command being recorded in the aforementioned medium may be a program command that is designed and configured especially for the present invention or a program command well known to those skilled in the art. Examples of a computer readable recording medium include a magnetic medium such as a hard disk, floppy disk, and magnetic tape; an optical medium such as a CD-ROM and DVD; a magneto-optical media such as a floptical disk; and any type of hardware apparatus especially configured to store and perform programs such as a ROM RAM, and flash memory. Examples of a program command include not only a machine language code such as that made by a compiler, but also a high-level language code that may be executed by a computer using an inter-printer and so forth. Such a hardware apparatus may be configured to operate as one or more software modules to perform operations of the present invention, and vice versa.

Teachings of principles of the present invention may be realized by a combination of hardware and software. Furthermore, they may also be realized as an application program that is actually realized in a program storage. Such an application program may be uploaded to a machine including any suitable architecture and be executed by the machine. Preferably, such a machine may be realized on a computer platform having one or more hardware such as a CPU, computer processor, random access memory (RAM), and input/output (I/O) interfaces. Furthermore, such a computer platform may include an operating system or micro command code. Various processes and functions aforementioned may be part of a micro command code, application program, or any combination thereof, and these may be executed by various processing apparatuses including a CPU. Furthermore, various peripheral apparatuses such as an additional data storage and printer may be connected to the computer platform.

Part of the configuration system components and methods illustrated in the attached drawings are preferably realized by software, and thus it should be understood that actual connection between the system components or process function blocks may differ according to the method in which the principles of the present invention are programmed. With the teachings given herein, those skilled in the art would be able to consider those principles of the present invention and similar embodiments or configurations.

A location type recognition apparatus according to an embodiment of the present invention will be described hereinafter.

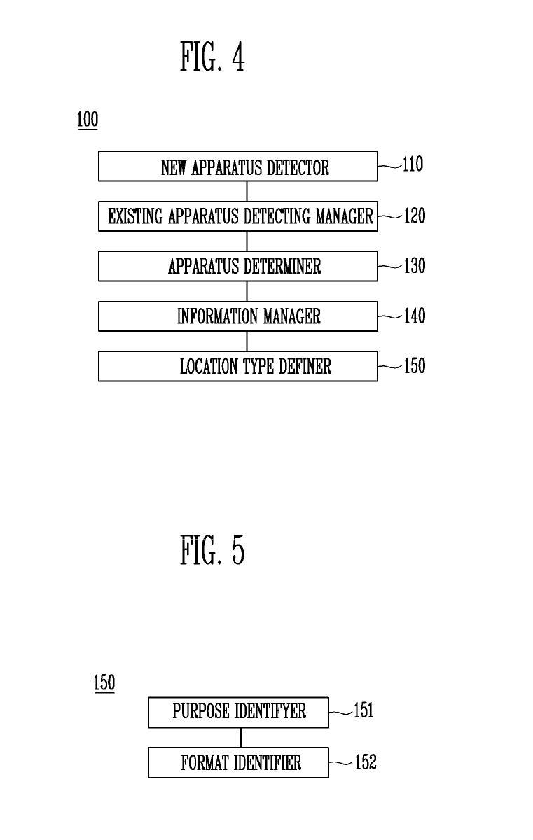

FIG. 4 is a block diagram illustrating a location type recognition apparatus according to an embodiment of the present invention. FIG. 5 is a block diagram illustrating a location type definer in a location type recognition apparatus according to an embodiment of the present invention.

Referring to FIG. 4, a location type recognition apparatus according to an embodiment of the present invention 100 includes a new apparatus detector 110, information manager 140, and location type definer 150. Furthermore, a location type recognition apparatus 100 according to an embodiment of the present invention 100 may further include an existing apparatus detecting manager 120, and apparatus determiner 130.

The new apparatus detector 110 detects a new service object apparatus capable of providing services to a user.

In response to the new service object apparatus not being detected in the new apparatus detector 110, the existing apparatus detecting manager 120 determines whether not the existing service object apparatus that was detected before is still detected. Furthermore, the existing apparatus detecting manager 120 stores information on the existing service object apparatus.

In response to the new service object apparatus being detected, the apparatus detector 130 determines whether or not the new service object apparatus is the existing service object apparatus detected before.

In response to the new service object apparatus being detected, the information manager 140 obtains information on the new service object apparatus from the new service object apparatus. Furthermore, in response to the new service object apparatus being detected that it is not the existing service object apparatus, the information manager 140 may obtain information the new service object apparatus. Furthermore, in response to the existing service object apparatus not being detected, the information manager 140 deletes information on the existing service object apparatus.

The location type definer 150 defines a location type of a predetermined place where the user is located using the information on the new service object apparatus. Referring to FIG. 5, the location type definer 150 may include a purpose identifier 151 for measuring a stay time at the predetermined place by the user and a format identifier 152 for determining a past visiting frequency at the predetermined place by the user. Furthermore, the location type definer 150 may define a location type of the predetermined place based on the stay time and the past visiting frequency. The location type definer 150 may define the location type of the predetermined place as one of a stay place, working place, and visiting place based on the stay time. Furthermore, the location type definer 150 may define the location type of the predetermined place as at least one of a cycle visiting place and temporary visiting place based on the past visiting frequency. Furthermore, the location type definer 150 may define the location type of the predetermined place using at least one of GPS information and visual information of the user.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A location type recognition method comprising:
detecting a new service object apparatus capable of providing services to a user;
in response to the new service object apparatus being detected, obtaining information on the new service object apparatus from the new service object apparatus; and
defining a location type of a predetermined place where the user is located using information on the new service object apparatus.

2. The method according to claim 1,
further comprising, in response to the new service object apparatus being detected, determining whether or not the new service object apparatus is an existing service object apparatus that was determined before,
wherein the obtaining information on the new service object apparatus is performed after it is determined that the new service object apparatus is not the existing service object apparatus.

3. The method according to claim 1,
wherein the detecting the new service object apparatus further comprises, in response to the new service object apparatus not being detected, determining whether or not the existing service object apparatus that was detected before is still being detected; and
in response to the existing service object apparatus not being detected, deleting information on the existing service object apparatus.

4. The method according to claim 1,
wherein the defining a location type comprises:
measuring a stay time at the predetermined place by the user; and
determining a past visiting frequency at the predetermined place by the user.

5. The method according to claim 4,
wherein the defining a location type defines a location type of the predetermined place based on the stay time and the past visiting frequency.

6. The method according to claim 4,
wherein the defining a location type defines a location of the predetermined place as one of a stay place, working place, and visiting place based on the stay time.

7. The method according to claim 4,
wherein the defining a location type defines a location of the predetermined place as at least one of a cycle visiting place and temporary visiting place.

8. The method according to claim 1,
wherein the defining a location type defines a location type of the predetermined place using at least one of GPS information and visual information of the user.

9. A location type recognition apparatus comprising:
a new apparatus detector for detecting a new object apparatus capable of providing services to a user;
an information managing for, in response to the new service object apparatus being detected, obtaining information the new service object apparatus from the new service object apparatus; and
a location type definer for defining a location type of a predetermined place where the user is located using the information on the new service object apparatus.

10. The apparatus according to claim 9,
further comprising an apparatus determiner for, in response to the new service object apparatus being detected, determining whether or not the new service object apparatus is an existing service object apparatus that was determined before,
wherein the information manager obtaining information on the new service object apparatus is performed after it is determined that the new service object apparatus is not the existing service object apparatus.

11. The apparatus according to claim 9,
wherein the new apparatus detector further comprises, in response to the new service object apparatus not being detected, an existing apparatus detecting manager for determining whether or not the existing service object apparatus that was detected before is still being detected; and
the information manager, in response to the existing service object apparatus not being detected, deleting information on the existing service object apparatus.

12. The apparatus according to claim 9,
wherein the defining a location type comprises:
a purpose identifier for measuring a stay time at the predetermined place by the user; and
a format identifier for determining a past visiting frequency at the predetermined place by the user.

13. The apparatus according to claim 12,
wherein the location type definer defines a location type of the predetermined place based on the stay time and the past visiting frequency.

14. The apparatus according to claim 12,
wherein the location type definer defines a location type of the predetermined place as one of a stay place, working place, and visiting place based on the stay time.

15. The apparatus according to claim 12,
wherein the location type definer defines a location type of the predetermined place as at least one of a cycle visiting place and temporary visiting place.

16. The apparatus according to claim 12,
wherein the location type definer defines a location type of the predetermined place using at least one of GPS information and visual information of the user.
